(19) United States
(12) Patent Application Publication
(10) Pub. No.: US 2020/0159083 A1
(43) Pub. Date: May 21, 2020

(54) SHAPE DEPENDENT CONVEX PROTRUSIONS IN TIR-BASED IMAGE DISPLAYS

(71) Applicant: ClearInk Displays, Inc., Fremont, CA (US)

(72) Inventors: Graham Beales, Vancouver, BC (CA); Lorne A. Whitehead, Vancouver, BC (CA); Bram M. Sadlik, Vancouver, BC (CA); Robert J. Fleming, San Jose, CA (US)

(73) Assignee: ClearInk Displays, Inc., Fremont, CA (US)

(21) Appl. No.: 16/630,131

(22) PCT Filed: Jul. 9, 2018
(86) PCT No.: PCT/US2018/041243

§ 371 Date: Jan. 10, 2020

Related U.S. Application Data
(60) Provisional application No. 62/530,763, filed on Jul. 10, 2017.

(51) Int. Cl. G02F 1/1677; G02F 1/167; G02F 1/1685

(52) U.S. Cl. CPC G02F 1/1677; G02F 2203/023; G02F 1/1685; G02F 1/167

(57) ABSTRACT

Brightness in total internal reflection image displays comprising of a color filter array may be enhanced by tuning the size and shape of the convex protrusions. Each protrusion or group of two or more protrusions may be aligned with a color filter sub-pixel such as red, green or blue, and with a thin film transistor. Each protrusion or group of two or more protrusions may be tuned to a specific size and shape with respect to the color filter sub-pixel it may be aligned with on a pixel by pixel basis. This may enhance the reflectance at the wavelength matching the desired color of the respective pixel.

### RELATED APPLICATIONS

The instant specification claims priority to the U.S. Provisional Application Ser. No. 62/530,763 (filed Jul. 10, 2017), the specification of which is incorporated herein in its entirety.

### FIELD

The disclosed embodiments generally relate to total internal reflection (TIR) in high brightness, wide viewing angle image displays. In one embodiment, the disclosure relates to a TIR image display comprising of a plurality of shape and size dependent convex protrusions substantially aligned with specific color filter sub-pixels.

### BACKGROUND

Conventional total internal reflection (TIR) based displays include, among others, a transparent high refractive index front sheet in contact with a low refractive index fluid. The front sheet and fluid may have different refractive indices that may be characterized by a critical angle θ_{c}. The critical angle characterizes the interface between the surface of the transparent front sheet (with refractive index η₁) and the low refractive index fluid (with refractive index η₃). Light rays incident upon the interface at angles less than θ_{c} may be transmitted through the interface. Light rays incident upon the interface at angles greater than θ_{c} may undergo TIR at the interface. A small critical angle (e.g., less than about 50°) is preferred at the TIR interface since this affords a large range of angles over which TIR may occur. It may be prudent to have a fluid medium with preferably as small a refractive index (η₃) as possible and to have a transparent front sheet composed of a material having a refractive index (η₁) preferably as large as possible. The critical angle, θ_{c}, is calculated by the following equation (Eq. 1):

$${θ}_{c} = {sin}^{- 1} ( \frac{{η}_{3}}{{η}_{1}} ) \qquad ( 1 )$$

Conventional TIR-based reflective image displays further include electrophoretically mobile, light absorbing particles. The electrophoretically mobile particles move in response to a bias between two opposing electrodes. When particles are moved by a voltage bias source towards the surface of the front sheet they may enter the evanescent wave region (depth of up to about 1 micron) and frustrate TIR. The evanescent wave region depth may vary due to such variables as the wavelength(s) of the incident light, the angle of the incident light and the refractive indices of the front sheet and the medium. Incident light may be absorbed by the electrophoretically mobile particles to create a dark, grey or colored state observed by the viewer. The states may be dependent on the number of particles and their location within the evanescent wave region. The dark or colored state may be the color of the particles or a color filter. Under such conditions, the display surface may appear dark or black to the viewer. When the particles are moved away from and out of the evanescent wave region (e.g., by reverse biasing), light may be reflected by TIR. This creates a white, bright or grey state that may be observed by the viewer. An array of pixelated electrodes may be used to drive the particles into and out of the evanescent wave region at individual pixels to form combinations of white and colored states, such as near the surface of a color filter. The combinations of white and colored states may be used to create images or to convey information to the viewer.

The front sheet in conventional TIR-based displays typically includes a plurality of higher refractive index close-packed convex structures on the inward side facing the lower refractive index medium and electrophoretically mobile particles (i.e., the surface of the front sheet which faces away from the viewer). The convex structures may be hemispherically-shaped but other shapes may be used. A conventional TIR-based display 100 is illustrated in FIG. 1A. Display 100 is shown with a transparent front sheet 102 with outer surface 104 facing viewer 106. Display 100 further comprising a layer of a plurality 108 of convex protrusions b 110, rear support sheet 112, transparent front electrode 114 on the surface of the plurality 108 of individual convex protrusions 110 and rear electrode 116. Rear electrode 116 may comprise a passive matrix array of electrodes, a thin film transistor (TFT) array or a direct drive array of electrodes. The rear array of electrodes may be formed in an array of pixels wherein each pixel may be driven by a TFT. FIG. 1A also shows low refractive index fluid 118 which is disposed within the cavity or gap 120 formed between the surface of protrusions 108 and rear support sheet 112. Fluid 118 contains a plurality of light absorbing electrophoretically mobile particles 122. Display 100 further includes a voltage bias source 124 capable of creating a bias across cavity 120. Display 100 may further comprise one or more dielectric layers 126, 128 on front electrode 114 or rear electrode 116 or on both the front and rear electrodes, and a color filter layer 130. Adding a color filter array (CFA) layer over the front surface of the display is a conventional method to transform a black and white reflective display into a full color display.

A color filter layer typically comprises one or more sub-pixel color filters. Sub-pixel color filters may comprise one or more colors of red, green, blue, white, black, clear, cyan, magenta or yellow. The sub-pixel color filters are typically arrayed in a repeatable pattern and are grouped into two or more colors to make a pixel. For illustrative purposes, a portion of prior art display 100 in FIG. 1A comprises color filter layer 130, further comprising a red sub-pixel color filter 132, a green sub-pixel color filter 134 and a blue sub-pixel color filter 136. Other sub-pixel color filter combinations may be used.

When particles 122 are electrophoretically moved towards front electrode 114 and into the evanescent wave region, they may frustrate TIR. This is shown to the right of dotted line 138 and is illustrated by incident light rays 140 and 142 being absorbed by particles 122. This area of the display, such as at a pixel, may appear as a dark, colored or grey state to viewer 106.

When particles are moved away from front sheet 102 and out of the evanescent wave region towards rear electrode 116 (as shown to the left of dotted line 138) incident light rays may be totally internally reflected at the interface of the surface of dielectric layer 126 on convex protrusion array 108 and medium 118. This is represented by incident light ray 144, which is totally internally reflected and exits the display towards viewer 106 as reflected light ray 146. The display pixel may appear white, bright, colored or grey to the viewer.

Conventional TIR-based display 100 may further comprise sidewalls 148 that bridge front sheet 102 to rear sheet 112. Sidewalls may comprise at least one dielectric layer 150. Display 100 may further comprise a directional front light system 152. Front light system 152 may comprise light source 154 and waveguide 156. Display 100 may further comprise an ambient light sensor (ALS) 158 and front light controller 160.

FIG. 1B schematically illustrates a cross-section of a portion of a conventional TIR-based display showing the approximate location of the evanescent wave region. Drawing 180 in FIG. 1B is a close-up view of a portion of drawing 100 in FIG. 1A. The evanescent wave region is located at the interface of dielectric layer 126 and medium 118. This location is illustrated in drawing 180, wherein the evanescent wave region 182 is located between dotted line 184 and dielectric layer 126. The evanescent wave is typically conformal to the surface of layer of protrusions 108. The depth of the evanescent wave region is about 1 micron, as previously mentioned.

The CFAs typically comprise combinations of sub-pixels of different colors in regular arrays (whereas a pixel is made up of several sub-pixels). If, for example, the CFA is an array that includes three different colored sub-pixels (such as red, green and blue (RGB)) in a single pixel, only a single color of the three sub-pixels is reflected from each sub-pixel. With a well-designed CFA this should reduce the reflectance of a surface that originally reflected white light to roughly one-third of its initial reflectance, since each pixel only reflects ⅓ of the original value. Because of this, the baseline reflectance of a reflective display intended for full-color must be about three times higher than conventional black and white designs. This is in order to maintain the same white-state brightness of conventional black and white designs in a full-color display. However, increasing the reflectance while maintaining the display's other optical characteristics (such as angular light acceptance and viewing angle) can be challenging.

### BRIEF DESCRIPTION OF DRAWINGS

These and other embodiments of the disclosure will be discussed with reference to the following exemplary and non-limiting illustrations, in which like elements are numbered similarly, and where:

FIG. 1A schematically illustrates a cross-section of a portion of a conventional TIR-based display;

FIG. 1B schematically illustrates a cross-section of a portion of a conventional TIR-based display showing the approximate location of the evanescent wave region;

FIG. 2 schematically illustrates a cross-section of a portion of a front sheet of a TIR-based display according to one embodiment of the disclosure;

FIG. 3 schematically illustrates a cross-section of a portion of a TIR-based display according to another embodiment of the disclosure;

FIG. 4 schematically illustrates an embodiment of a portion of an active matrix thin film transistor array for driving a flexible or conformal TIR-based display;

FIG. 5 schematically illustrates an exemplary system for implementing an embodiment of the disclosure;

FIG. 6 graphically illustrates the reflectance of light in a display as a function of convex protrusion size at different wavelengths of light; and

FIG. 7 graphically illustrates the reflectance of light in a display as a function of convex protrusion size at different angles of incidence.

### DETAILED DESCRIPTION

Throughout the following description specific details are set forth in order to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive sense.

In certain embodiments, the disclosure describes a method (as well as system and apparatus) to increase the reflectance of a full-color reflective display by tuning the display's convex optical structures on a sub-pixel-by-sub-pixel basis such that each sub-pixel may have a greater reflectance at the wavelength (i.e., wavelength bands) matching the sub-pixel's desired color. This may be done by changing the size and shape of the convex structures to create optical structures which preferentially reflect light at the wavelength(s) associated with the desired color. In an exemplary embodiment, a plurality of convex protrusions of a first size and shape may be substantially aligned with a sub-pixel color filter of a first color, a plurality convex protrusions of a second size and shape may be substantially aligned with a sub-pixel color filter of a second color and a plurality of convex protrusions of a third size and shape may be substantially aligned with a sub-pixel color filter of a third color and so forth such that the sizes and shapes of the convex protrusions (convex protrusions may also be referred to as optical structures) preferentially or optimally reflects light at the wavelengths required to match the sub-pixel color filter. In an exemplary embodiment, the number of pluralities of convex protrusions of a particular size and shape should be equal to the number of sub-pixel color filter colors. The number of pluralities of convex protrusions of a particular size and shape and the number of sub-pixel color filter colors may be about two or more.

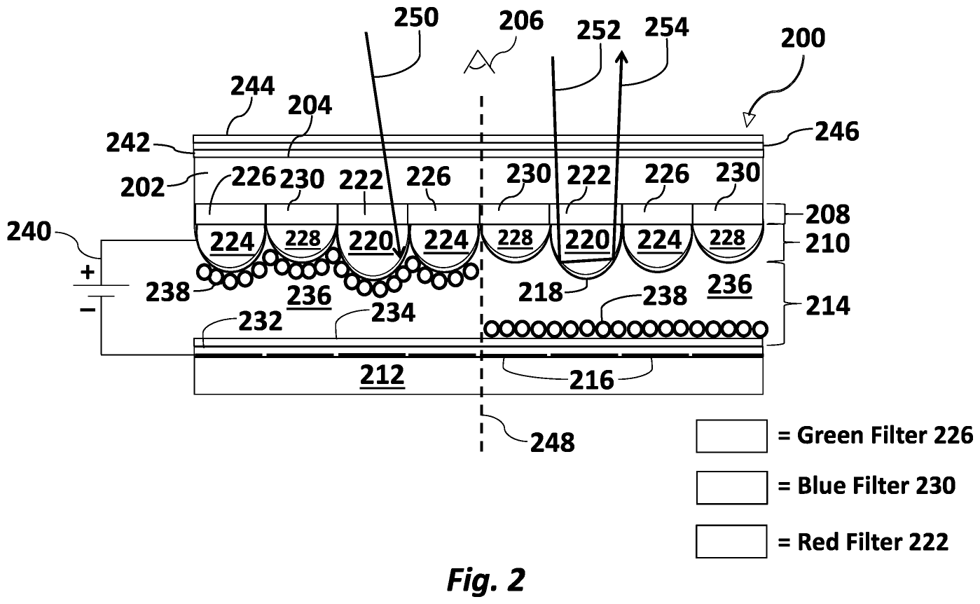

FIG. 2 schematically illustrates a cross-section of a portion of a front sheet of a TIR-based display according to one embodiment of the disclosure. Display embodiment 200 is similar to prior art display 100. Display embodiment 200 comprises transparent front sheet 202 with outer surface 204 facing viewer 206. In an exemplary embodiment, sheet 202 may comprise a flexible glass. In an exemplary embodiment, sheet 202 may comprise glass of thickness in the range of about 20-250 μm. Sheet 202 may comprise a flexible glass such as SCHOTT AF 32® eco or D 263® T eco ultra-thin glass. Sheet 202 may comprise a polymer such as polycarbonate. In an exemplary embodiment, sheet 202 may comprise a flexible polymer.

The exemplary embodiment 200 shows color filter array layer 208 located between front sheet 202 and an inward array layer of convex protrusions 210. In some embodiments, color filter array layer 208 may be located on outer surface 204 of sheet 202 facing viewer 206. Color filter layer 208 may include one or more of red (R), green (G), blue (B), black, clear, white (W), cyan, magenta or yellow sub-pixel color filters. Color filter layer 208 may comprise one or more black, white or transparent masks or borders around one or more color filter sub-pixels or groups of color filter sub-pixels. In an exemplary embodiment, color filter array layer 208 may comprise a PenTile™ array of sub-pixel color filters. Color filter array layer 208 may comprise one or both of PenTile™ RGBG (also known as Takahashi) array of sub-pixel filters or PenTile™ RGBW array of sub-pixel filters.

In some embodiments, front sheet 202 and protrusions 210 may be a continuous sheet of the same material wherein color filter array 208 may be located over outer surface 204 of sheet 202 facing viewer 206. In other embodiments, front sheet 202 and protrusions 210 may be separate layers and comprise different materials. In an exemplary embodiment, sheet 202 and protrusions 210 may comprise different refractive indices. In an exemplary embodiment, protrusions 210 may comprise a high refractive index polymer. In some embodiments, convex protrusions 210 may be in the shape of hemispheres. In an exemplary embodiment, protrusions 210 may be arranged in a close-packed array. Protrusions 210 may be of any shape or size or a mixture of shapes and sizes. Protrusions 210 may be elongated hemispheres or hexagonally shaped or a combination thereof. In other embodiments, convex protrusions 210 may be microbeads embedded in sheet 202.

Protrusions 210 may have a refractive index of about 1.4 or higher. In an exemplary embodiment, protrusions 210 may have a refractive index in the range of about 1.5-1.9. In certain embodiments, the protrusions may include materials having a refractive index in the range of about 1.5 to 2.2. In certain other embodiments, the high refractive index protrusions may be a material having a refractive index of about 1.6 to about 1.9. The protrusions may have a diameter of at least about 0.5 microns. The protrusions may have a diameter of at least about 2 microns.

In some embodiments the protrusions may have a diameter in the range of about 0.5-5000 microns. In other embodiments the protrusions may have a diameter in the range of about 0.5-500 microns. In still other embodiments the protrusions may have a diameter in the range of about 0.5-100 microns.

Protrusions 210 may have a height of at least about 0.5 microns. In some embodiments the protrusions may have a height in the range of about 0.5-5000 microns. In other embodiments the protrusions may have a height in the range of about 0.5-500 microns. In still other embodiments the protrusions may have a height in the range of about 0.5-100 microns.

High refractive index polymers that may be used to form convex protrusions 210 may comprise high refractive index additives such as metal oxides. The metal oxides may comprise one or more of SiO₂, ZrO₂, ZnO₂, ZnO or TiO₂. In some embodiments, convex protrusions 210 may be in the shape of hemispheres. Protrusions 210 may be of any shape or size or a mixture of shapes and sizes. In some embodiments, the convex protrusions may be randomly sized and shaped. In some embodiments the protrusions may be faceted at the base and morph into a smooth hemispherical or circular shape at the top. In other embodiments, protrusions 210 may be hemispherical or circular in one plane and elongated in another plane. In an exemplary embodiment, the convex protrusions 204 may be manufactured by micro-replication. In an exemplary embodiment, sheet 202 may be a rigid, flexible, stretchable or impact resistant material while protrusions 210 may comprise a rigid, high index material.

Display embodiment 200 may comprise a rear support layer 212. Display 200 may comprise a rigid, flexible or conformal rear support layer 212. Rear support layer 212 may be one or more of a metal, polymer, wood or other material. Layer 212 may be one or more of glass, polycarbonate, polymethylmethacrylate (PMMA), polyurethane, acrylic, polyvinylchloride (PVC), polyimide or polyethylene terephthalate (PET). Rear support 212 may form a gap or cavity 214 therebetween with the layer of convex protrusions 210.

Rear support 212 may be further equipped with a rear electrode layer 216. Rear electrode layer 216 may be rigid, flexible or conformal. Layer 216 may comprise transparent conductive material or non-transparent conductive material such as aluminum, gold or copper. Rear electrode layer 216 may be vapor deposited or electroplated. Rear electrode 216 may be continuous or patterned. Rear electrode 216 may be integrated with rear support layer 212. Alternatively, rear electrode 216 may be positioned proximal to rear support 212. In another embodiment, rear electrode 216 may be laminated or attached to rear support layer 212. Rear electrode layer 216 may comprise a thin film transistor (TFT) array or a passive matrix array. Rear electrode layer 216 may comprise a direct drive patterned array of electrodes or a segmented array of electrodes. Rear electrode layer 216 may comprise an active matrix of organic field-effect transistors (FETs). The organic FETs may comprise an active semiconducting layer of a conjugated polymer or a small conjugated molecule. The organic FETs may comprise an organic dielectric layer in the form of either a solution processed dielectric or a chemical vapor deposited dielectric.

Layer 216 may comprise aluminum, ITO, copper, gold or other electrically conductive material. In one embodiment, layer 216 may comprise organic TFTs. In other embodiments, rear electrode layer 216 may comprise indium gallium zinc oxide (IGZO) TFTs. Layer 216 may comprise low temperature polysilicon, low temperature polysilicon manufactured by a polyimide “lift-off” process, amorphous silicon on a rigid or flexible substrate. In an exemplary embodiment, each TFT of rear electrode layer 216 may be substantially aligned or registered with at least one sub-pixel filter in color filter array layer 208.

Display 200 may further comprise a front electrode layer 218 on the surface of the convex protrusions 210. Front electrode layer 218 may be rigid, flexible or conformable. Front electrode layer 218 may comprise a transparent conductive material such as indium tin oxide (ITO), Baytron™, or conductive nanoparticles, silver wires, metal nanowires, graphene, nanotubes, or other conductive carbon allotropes or a combination of these materials dispersed in a substantially transparent polymer. Front electrode layer 218 may comprise a transparent conductive material further comprising silver nano-wires manufactured by C3Nano (Hayward, Calif., USA). Front electrode layer 218 may comprise C3Nano ActiveGrid™ conductive ink.

Display 200 may comprise at least one convex protrusion of a first size and shape. Display 200 may comprise two or more pluralities of convex protrusions wherein each plurality has a particular size and shape. In an exemplary embodiment, at least one convex protrusion of a first size and shape in layer 210 may be substantially aligned with a sub-pixel color filter of a first color in layer 208.

In certain embodiments, the size and shape of a convex structure is configured to correspond to a particular sub-pixel color in order to preferentially reflect light at the wavelength bands associated with the desired particular sub-pixel filter color. In one embodiment, the size and shape of the convex protrusion is configured to allow maximum reflection of the light having wavelength bands corresponding to a sub-pixel's color filter. For example, if the sub-pixel has a red filter (red has a wavelength band of about 620-750 nm), then the shape (e.g., arc of the roundness) and size (e.g., length of the hemisphere) are selected to accommodate maximum reflection of the incident light from the corresponding portion of the display. This principle may be extended to sub-pixels of different color. By configuring the size and shape of the protrusion, reflectance of an incident light ray may be maximized at a viewing angle or at a range of viewing angles.

In an exemplary embodiment, substantially one or more convex protrusions with a first shape and size 220 are substantially aligned with the red sub-pixel filters 222, one or more of the convex protrusions with a second shape and size 224 are substantially aligned with the green sub-pixel filters 226, and one or more of all convex protrusions with a third shape and size 228 are substantially aligned with the blue sub-pixel filters 230. In an exemplary embodiment, a plurality of convex protrusions of a first size and shape may be substantially aligned with a sub-pixel color filter of a first color, a plurality convex protrusions of a second size and shape may be substantially aligned with a sub-pixel color filter of a second color and a plurality of convex protrusions of a third size and shape may be substantially aligned with a sub-pixel color filter of a third color and so forth such that the sizes and shapes of the convex protrusions (i.e. optical structures) optimally reflects light at the wavelengths required to match the sub-pixel color filter. In an exemplary embodiment, the number of pluralities of convex protrusions of a particular size and shape should be equal to the number of sub-pixel color filter colors. The number of pluralities of convex protrusions of a particular size and shape matched with a particular color of sub-pixel color filter may be about two or more.

In an exemplary embodiment, each convex protrusion may be aligned with a color filter and a TFT to form a sub-pixel. In an exemplary embodiment, each group of convex protrusions of a first, second or third group of sizes and shapes, are tuned on a sub-pixel-by-sub-pixel basis so that each pixel may have a greater reflectance at the wavelength matching the sub-pixel's desired color. This may be done by changing the size and shape of the convex protrusions to create optical structures which preferentially reflect light at the wavelength(s) associated with the desired color. Firstly, while the tuning of the size and shapes of the protrusions may decrease the reflectance of the light at non-desired wavelength bands, this loss may not be apparent as the color filter already makes any reflectance at non-desired wavelength bands negligible. Secondly, any gains in reflectance at the desired wavelengths due to this tuning may not be lost by the color filter, as they are at wavelengths which may not be filtered out. In other words, in certain embodiments, rather than optimizing a broadband structure and then discarding light with a color filter, a structure may be created to optimize a desired frequency band so that the reflected light may be both already colored and have a higher reflectance in the wavelength band that corresponds to that color.

In an exemplary embodiment, display 200 may comprise a planarization layer 232. Planarization layer 232 may be used to smooth the surface of the backplane drive electronics in layer 216. This may allow complete sidewalls or partial sidewalls to be placed or formed on top of the planarization layer. Planarization layer 232 may comprise a polymer. Planarization layer 232 may be deposited using a slot die coating process or flexo-print process. Planarization layer 232 may comprise a photoresist. Planarization layer 232 may also act as a dielectric layer. Planarization layer 232 may comprise a polyimide.

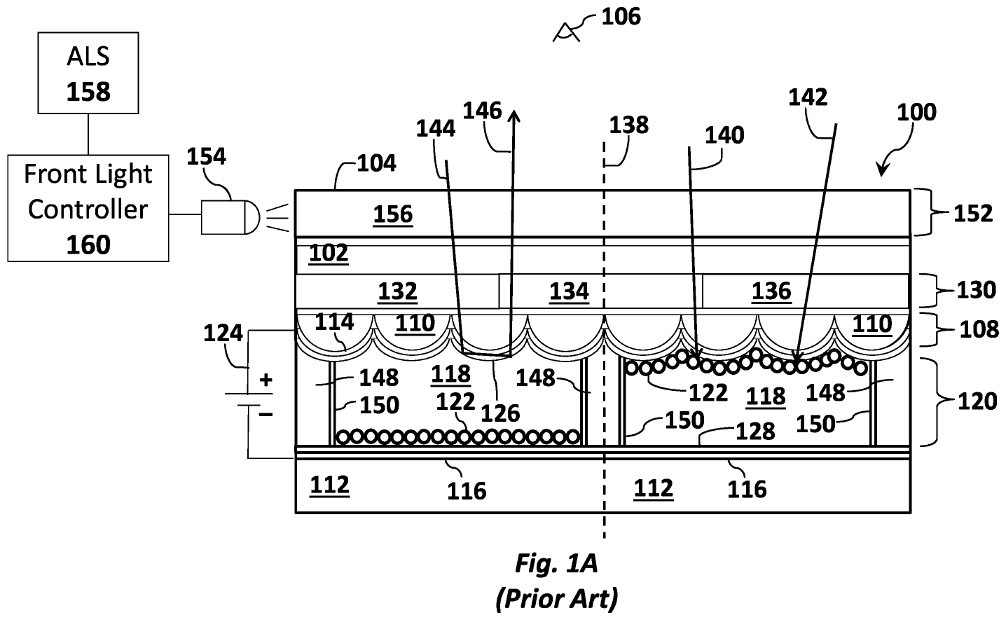

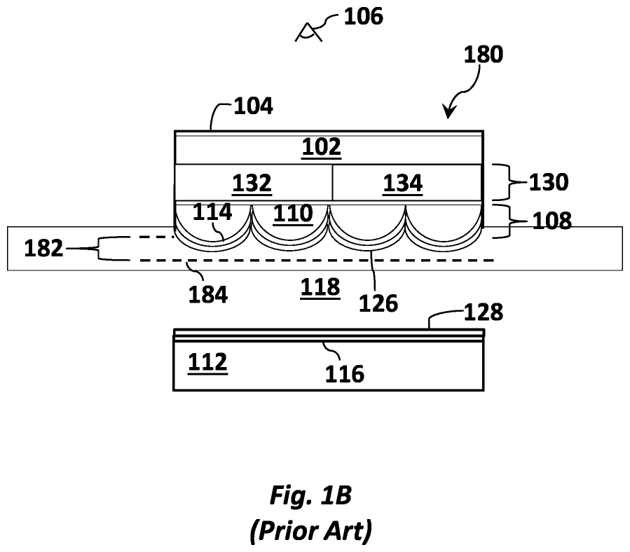

Display 200 may further include at least one optional dielectric layer on one or more of the front electrode 218, rear electrode layer 216 or planarization layer 232. For illustrative purposes only, display 200 shows dielectric layer 234 on planarization layer 232, but layer 234 may be located elsewhere as described. In some embodiments, a dielectric layer on front electrode 218 (as illustrated in FIG. 1A) may comprise a different composition than a dielectric layer 234 on rear electrode 216. In an exemplary embodiment, the optional dielectric layers may comprise two or more sub-layers of dielectric materials. The sub-layers may comprise different materials. For example, a front dielectric layer or rear dielectric layer 234 may comprise a sub-layer of SiO₂ and a second sub-layer of polyimide. The dielectric layers may be substantially uniform, continuous and substantially free of surface defects. The dielectric layers may be at least about 0.05 nm (i.e., approximately a monolayer) in thickness or more. In some embodiments, the dielectric layer thicknesses may be in the range of about 1-300 nm. In other embodiments, the dielectric layer thicknesses may be in the range of about 1-200 nm. In still other embodiments, the dielectric layer thicknesses may be about 1-100 nm. In still other embodiments, the dielectric layer thicknesses may be about 1-50 nm. In still other embodiments, the dielectric layer thicknesses may be about 1-20 nm. In still other embodiments, the dielectric layer thicknesses may be about 1-10 nm. The dielectric layers may comprise at least one pin hole. The dielectric layer may define a conformal coating and may be free of pin holes or may have minimal pin holes. The dielectric layer may also be a structured layer. The dielectric layer may also act as a barrier layer to prevent moisture or gas ingress. The dielectric layers may have a high or low dielectric constant. In some embodiments, the dielectric layers may have a dielectric constant in the range of about 1-30. In other embodiments, the dielectric layers may have a dielectric constant in the range of about 1-15. Dielectric compounds may be organic or inorganic in type. The most common inorganic dielectric material is SiO₂ commonly used in integrated chips. The dielectric layer may be one or more of SiOₓ, SiN, SiNₓ or SiON. The one or more dielectric layers may comprise one or more of Al₂O₃, AlOₓ, CaO, CuO, Er₂O₃, Ga₂O₃, HfO₂, HfOₓ, InZnO, InGaZnO, La₂O₃, MgO, Nb₂O₅, Sc₂O₃, SnO₂, Ta₂O₅, TiO₂, V_{X}O_{Y}, Y₂O₃, Yb₂O₃, ZnSnOₓ, ZnO, ZrO₂, AlN, BN, GaN, SiN, SiNₓ, TaN, TaN_{X}, TiAlN, TiN, WN or TiN_{X}. The dielectric layer may be a ceramic. Organic dielectric materials are typically polymers such as polyimides, fluoropolymers, polynorbornenes and hydrocarbon-based polymers lacking polar groups. The dielectric layers may be a polymer or a combination of polymers. The dielectric layers may be combinations of polymers, metal oxides and ceramics. The dielectric layers may comprise one or more of the following polyimide-based dielectrics Dalton DL-5260T, TC-139, DL-2193, Nissan SE-150, SE-410, SE-610, SE-3140N, SE-3310, SE-3510, SE-5661, SE-5811, SE-6414, SE-6514, SE-7492, SE-7992 or JSR AL-1054, AL-3046, AL22620, AL16301, AL60720. In an exemplary embodiment, the dielectric layers comprise Parylene. In other embodiments the dielectric layers may comprise a halogenated Parylene. The dielectric layers may comprise Parylene C, Parylene N, Parylene F, Parylene HT or Parylene HTX. Other inorganic or organic dielectric materials or combinations thereof may also be used for the dielectric layers. One or more of the dielectric layers may be CVD, PECVD or sputter coated. One or more of the dielectric layers may be a solution coated polymer, vapor deposited dielectric or sputter deposited dielectric. Dielectric layer 234 may be conformal to rear electrode structures or could be used to planarize the electrode structures. Planarization of the electrode structures leading to a smoother and more even surface may allow for deposition of sidewalls with more uniform height and thicknesses.

In an exemplary embodiment, one or more dielectric layers in display 200 may be deposited by one or more methods of chemical vapor deposition (CVD), plasma enhanced chemical vapor deposition (PECVD) or thermal or plasma enhanced atomic layer deposition (ALD).

Display embodiment 200 may further comprise a low refractive index medium 236 located between the front electrode layer 218 and rear electrode layer 216 in gap 214. Medium 236 may be air or a liquid. Medium 236 may be an inert, low refractive index fluid medium. Medium 236 may be a hydrocarbon. In some embodiments the refractive index of medium 236 may be in the range of about 1 to 1.5. In still other embodiments, the refractive index of medium 236 may be about 1.1 to 1.4. In an exemplary embodiment, medium 236 may be a fluorinated hydrocarbon. In another exemplary embodiment, medium 236 may be a perfluorinated hydrocarbon. In an exemplary embodiment, medium 236 has a refractive index less than the refractive index of convex protrusions 210. In other embodiments, medium 236 may be a mixture of a hydrocarbon and a fluorinated hydrocarbon. In an exemplary embodiment, medium 236 may comprise one or more of Fluorinert™, Novec™ 7000, Novec™ 7100, Novec™ 7300, Novec™ 7500, Novec™ 7700, Novec™ 8200, electrowetting materials, Teflon™ AF, CYTOP™ or Fluoropel™.

Medium 236 may further comprise one or more of a viscosity modifier or a charge control agent. Conventional viscosity modifiers include oligomers or polymers. Viscosity modifiers may include one or more of a styrene, acrylate, methacrylate or other olefin-based polymers. In one embodiment, the viscosity modifier is polyisobutylene. In another embodiment, the viscosity modifier is a halogenated polyisobutylene.

Medium 236 may further include a first plurality of light absorbing electrophoretically mobile particles 238. Mobile particles 238 may comprise a first charge polarity and first optical characteristic (i.e. color or light absorption characteristic). In some embodiments, medium 236 may further include a second plurality of electrophoretically mobile particles and may comprise a second charge of opposite polarity and a second optical characteristic. Particles 238 may be formed of an organic material or an inorganic material or a combination of an organic and inorganic material. Particles 238 may be a dye or a pigment or a combination thereof. Particles 238 may be at least one of carbon black, graphene, a metal or metal oxide. The particles may have a polymer coating. In one embodiment, particles 238 may comprise a positive charge polarity or a negative charge polarity or a combination thereof. Particles 238 may comprise weakly charged or uncharged particles. Particles 238 may be light absorbing or light reflecting or a combination thereof.

In another embodiment, display embodiment 200 may comprise a plurality of light absorbing particles 238 and a second plurality of light reflecting particles. The light reflecting particles may comprise a white reflective particle such as titanium dioxide (TiO₂). The light reflecting particles may be around 200-300 nm. This is a typical size of TiO₂ particles used in the paint industry to maximize the light reflectance properties. Particles of larger or smaller sizes may also be used. The light reflecting particles may further comprise a coating (not shown) such as Al₂O₃ or SiO₂ or a combination thereof. The coating may comprise of an effective refractive index that is substantially similar to the refractive index of medium 236. In some embodiments, the difference between the refractive indices of the coating on the light reflecting particles and medium 236 may be about 40% or less. In other embodiments, the difference between the refractive indices of the coating on the light reflecting particles and medium 236 may be about 0.5-40%.

In other embodiments, an electrowetting fluid may be located in gap 214. In an exemplary embodiment, the electrowetting fluid may comprise a dye. The electrowetting fluid may move towards protrusions 210 into the evanescent wave region to frustrate TIR. The electrowetting fluid may move away from protrusions 210 and out of the evanescent wave region to allow for TIR. The electrowetting fluid may be a silicone oil that may be pumped via small channels into and out of the wells formed by sidewalls.

Display embodiment 200 may comprise a voltage bias source 240. Bias source 240 may create an electromagnetic flux in gap 214 formed between front electrode 218 and rear electrode 216. The flux may extend to any medium 236 disposed in the gap. The flux may move at least one of particles 238 towards one electrode and away from the opposing electrode.

Bias source 240 may be coupled to one or more processor circuitries and memory circuitries configured to change or switch the applied bias in a predefined manner and/or for predetermined durations. For example, the processing circuity may switch the applied bias to display characters on display 200.

In some embodiments, display 200 in FIG. 2 may comprise at least one transparent barrier layer 242. Barrier layer 242 may be located on the outer surface 204 of sheet 202. Barrier layer 242 may be located in various locations within the TIR-based display embodiment described herein. Barrier layer 242 may act as one or more of a gas barrier or moisture barrier and may be hydrolytically stable. Barrier layer 242 may be one or more of a rigid, flexible or conformable polymer. Barrier layer 242 may comprise one or more of polyester, polypropylene, polyethylene terephthalate, polyethylene naphthalate or copolymer, or polyethylene. Barrier layer 242 may comprise one or more of a chemical vapor deposited (CVD) or sputter coated ceramic-based thin film on a polymer substrate. The ceramic may comprise one or more of Al₂O₃, SiO₂ or other metal oxide. Barrier layer 242 may comprise one or more of a Vitriflex barrier film, Invista OXYCLEAR® barrier resin, Toppan GL™ barrier films GL-AEC-F, GX-P-F, GL-AR-DF, GL-ARH, GL-RD, Celplast Ceramis® CPT-036, CPT-001, CPT-022, CPA-001, CPA-002, CPP-004, CPP-005 silicon oxide (SOₓ) barrier films, Celplast CAMCLEAR® aluminum oxide (AlOx) coated clear barrier films, Celplast CAMSHIELD® T AlOx-polyester film, Torayfan® CBH or Torayfan® CBLH biaxially-oriented clear barrier polypropylene films.

In some embodiments, display 200 may comprise a diffuser layer 244. Diffuser layer 244 may be used to soften the incoming light or reflected light or to reduce glare. Diffuser layer 244 may comprise a rigid or flexible polymer or glass. Diffuser layer 244 may comprise ground glass in a flexible polymer matrix. Layer 244 may comprise a micro-structured or textured polymer. Diffuser layer 244 may comprise 3M™ anti-sparkle or anti-glare film. Diffuser layer 244 may comprise 3M™ GLR320 film (Maplewood, Minn.) or AGF6200 film. Diffuser layer 244 may be located at one or more various locations within display embodiment 200. In an exemplary embodiment, diffuser layer 244 may be located be located between sheet 202 and viewer 206.

In exemplary embodiments, display 200 may comprise one or more sidewalls (not shown). Sidewalls in display 200 are similar to sidewalls 148 in display 100 illustrated in FIG. 1A. Sidewalls may also be referred to as cross-walls, partition walls or pixel walls. Sidewalls may limit particle settling, drift and diffusion to improve display performance and image stability. In an exemplary embodiment, sidewalls may substantially maintain a uniform gap distance between front electrode 218 and rear electrode layer 216. Sidewalls may also act as a barrier to aid in preventing prevent moisture and oxygen ingress into the display. Sidewalls may be located within the light modulation layer comprising particles 238 and medium 236. Sidewalls may completely or partially extend from the front electrode, rear electrode or both the front and rear electrodes. Sidewalls may comprise polymer, metal or glass or a combination thereof. Sidewalls may be any size or shape. Sidewalls may have a rounded cross-section. Sidewalls may have a refractive index within about 0.01-0.2 of the refractive index of convex protrusions 210. In an exemplary embodiment sidewalls may be optically active. Sidewalls may create wells or compartments to confine electrophoretically mobile particles 238 suspended in medium 236. Sidewalls may be configured to create wells or compartments in, for example, square-like, triangular, pentagonal or hexagonal shapes or a combination thereof. Sidewalls may comprise a polymeric material and patterned by one or more conventional techniques including photolithography, embossing or molding. In certain embodiments, display 200 comprises sidewalls that completely bridge gap 214. In other embodiments, display embodiment 200 may comprise partial sidewalls that only partially bridge gap 214. In certain embodiments, the reflective image display 200 may comprise a combination of sidewalls and partial sidewalls that may completely or partially bridge gap 214. In an exemplary embodiment, sidewalls may be comprised of a rigid, flexible or conformal polymer. In other embodiments, sidewalls may be substantially aligned with color filter sub-pixels of color filter layer 208. In an exemplary embodiment, sidewalls may be formed such that they substantially surround a pixel comprising a combination of color filter sub-pixels such as RBG, RGBG, RGBW, RGBY or other combinations.

In some embodiments, sidewalls may be formed on top of rear dielectric layer 234, rear electrode layer 216, planarization layer 232 or rear substrate 212. Display 200 may comprise sidewalls directly on top of rear dielectric layer 234 as illustrated in the example in FIG. 1A where sidewalls 148 are formed directly on rear dielectric later 128. In other embodiments, sidewalls may be formed as part of the array of convex protrusions 210. Sidewalls and convex protrusions 210 may be formed by the same micro-replication process. A dielectric layer may be subsequently formed on both the front electrode layer 218 and sidewalls. Sidewalls may be formed on top of planarization layer 232.

In some embodiments, display 200 in FIG. 2 may comprise one or more dielectric layers (not shown) located on the surface of the sidewalls as illustrated in FIG. 1A. The dielectric layer may comprise of similar materials described previously herein for dielectric layer 234. The dielectric layer on the surface of a sidewall may be formed by methods such as CVD, PECVD, sputter coated, solution coated, vapor deposited, thermal or plasma enhanced ALD. The dielectric layer may comprise two or more dielectric sub-layers. The sub-layers may comprise of the same or different materials. The sub-layers may be formed by different deposition processes.

In some embodiments, display 200 may further comprise a conductive cross-over (not shown) in FIG. 2. A conductive cross-over may bond to the front electrode layer 218 and to a trace on rear electrode layer 216 such as a TFT. This may allow a driver integrated circuit (IC) to control the voltage at front electrode 218. In an exemplary embodiment, the conductive cross-over may comprise an electrically conductive adhesive that is flexible or conformal.

In exemplary embodiments, display 200 may comprise a directional front light system (not shown in FIG. 2) as illustrated in display 100 in FIG. 1A. The directional front light system may comprise an outer surface facing viewer 206. The directional front light system may comprise a light source to emit light through an edge of a light guide. The light source may comprise one or more of a light emitting diode (LED), cold cathode fluorescent lamp (CCFL) or a surface mounted technology (SMT) incandescent lamp. In an exemplary embodiment, the light source may define an LED whose output light emanates from a refractive or reflective optical element that concentrates said diode's output emission in a condensed angular range to an edge of the light guide. In some embodiments, the light source may be optically coupled to the light guide.

The light guide may comprise one or more of a rigid, flexible or conformable polymer. The light guide may comprise more than one layer. The light guide may comprise one or more contiguous light guiding layers parallel to each other. The light guide may comprise at least a first light guiding layer that forms a transparent bottom surface. The light guide may comprise a second layer that forms a transparent top or outer surface. The light guide may comprise a third layer that forms a central transparent core. The refractive indices of the layers of the light guide may differ by at least 0.05. The multiple layers may be optically coupled. In an exemplary embodiment, the light guide may comprise an array of light extractor elements. The light extractor elements may comprise one or more of light scattering particles, dispersed polymer particles, tilted prismatic facets, parallel prism grooves, curvilinear prism grooves, curved cylindrical surfaces, conical indentations, spherical indentations, aspherical indentations or air pockets. The light extractor elements may be arranged such that they redirect light towards a semi-retro-reflective display sheet in a substantially perpendicular direction with a non-Lambertian narrow-angle distribution. The light guide may comprise diffusive optical haze. The light guide may be configured to direct light to the front entire surface of the transparent outer sheet while the light extractor elements direct the light in a perpendicular direction within a narrow angle, for example, centered about a 30° cone, towards front sheet 202. The light guide system may comprise a FLEx Front Light Panel made from FLEx Lighting (Chicago, Ill.). The light guide may comprise an ultra-thin, flexible light guide film manufactured by Nanocomp Oy, Ltd. (Lehmo, Finland).

In some embodiments, display 200 in FIG. 2 may further comprise an ALS and front light controller as illustrated in display 100 in FIG. 1A.

In some embodiments, display 200 in FIG. 2 may include at least one optically clear adhesive (OCA) layer 246. OCA's may be used to adhere display layers together and to optically couple layers throughout the display. For example, an OCA layer may be used to adhere and optically couple a front light system to outer surface 204 of sheet 202. Display embodiment 200 may comprise optically clear adhesive layers further comprised of one or more of 3M™ optically clear adhesives 3M™ 8211, 3M™ 8212, 3M™ 8213, 3M™ 8214, 3M™ 8215, 3M™ OCA 8146-X, 3M™ OCA 817X, 3M™ OCA 821X, 3M™ OCA 9483, 3M™ OCA 826XN or 3M™ OCA 8148-X, 3M™ CEF05XX, 3M™ CEF06XXN, 3M™ CEF19XX, 3M™ CEF28XX, 3M™ CEF29XX, 3M™ CEF30XX, 3M™ CEF31, 3M™ CEF71XX, Lintec MO-T020RW, Lintec MO-3015UV series, Lintec MO-T015, Lintec MO-3014UV2+, Lintec MO-3015UV.

Display embodiment 200 in FIG. 2 may be operated as follows. Electrophoretically mobile particles 238 may be moved near or away from front electrode 218. It is assumed in FIG. 2 that particles 238 have a negative charge polarity for illustrative purposes only. In some embodiments, particles 238 may comprise a positive charge polarity. In some embodiments, particles 238 may comprise a negative and positive charge. When a positive voltage bias is applied at front electrode 218 by bias source 240, negative charge polarity particles 238 may be moved into the evanescent wave region near front electrode 218. This is illustrated on the left side of dotted line 248 in FIG. 2. When particles 238 are located in the evanescent wave region, they may absorb incident light and frustrate TIR creating a dark state at a pixel. This is illustrated in FIG. 2 by representative incident light ray 250. Light ray 250 passes through display 200 where it may be absorbed by particles 238.

Illustrated on the right side of dotted line 248, a positive voltage bias may be applied by bias source 240 at rear electrode 216. Negatively charged particles 238 may be moved near the rear electrode layer 216. When particles 238 are located away from front electrode 218 and out of the evanescent wave region, light may be totally internally reflected at the interface of electrode layer 218 (or a dielectric layer in some embodiments) and low refractive index medium 236. This allows incident light to be reflected in a semi-retroreflective manner back towards viewer 206. This creates a light or bright state as observed by viewer 206. This is represented by incident light ray 252 that is reflected by TIR back towards viewer 206. The reflected light ray is represented by ray 254. The bright and dark states of the display embodiments described herein may be modulated by movement of particles 238 in medium 236 by bias source 240.

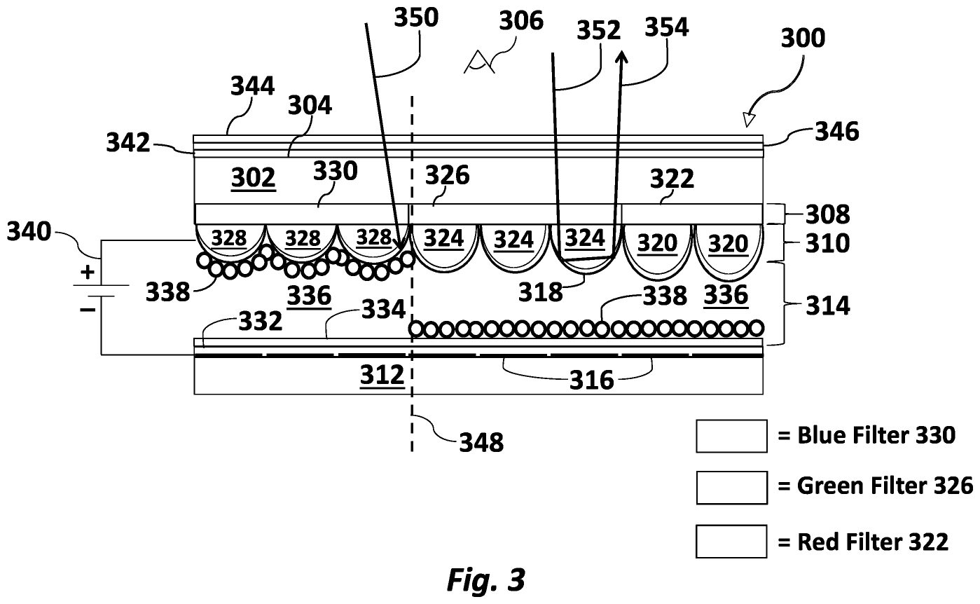

FIG. 3 schematically illustrates a cross-section of a portion of a TIR-based display according to another embodiment of the disclosure. Display embodiment 300 in FIG. 3 is similar to display embodiment 200. Display 300 comprises a transparent front sheet 302 with outer surface 304 facing viewer 306, color filter array layer 308, layer of inwardly protruding convex protrusions 310, rear support layer 312, gap 314, rear electrode layer 316 and front electrode layer 318.

Display 300 further comprises a plurality of protrusions 320 of a first size and shape substantially aligned with red sub-pixel color filters 322, a second plurality of protrusions 324 of a second size and shape substantially aligned with green sub-pixel color filters 326, and a third plurality of protrusions of a third size and shape 328 substantially aligned with blue sub-pixel color filters 330. In this embodiment, more than one convex protrusions of substantially the same size and shape may be aligned with a single color sub-pixel color filter. This is in contrast to display embodiment 200 where each convex protrusion is aligned with a single sub-pixel color filter. In display 300, the number of different sub-pixel color filters is approximately equal to the number of convex protrusions of a distinct size and shape. For example, if a color filter array comprises RGBW sub-pixel color filters, then there would exist four different pluralities of convex protrusions with each plurality having a unique size and shape that preferentially and optimally reflects light at the wavelengths required to match the color of one of the four sub-pixel color filters. In an exemplary embodiment, each group of convex protrusions of a particular size and shape matched with a sub-pixel color filter may further be substantially aligned with a TFT in rear electrode layer 316.

Display 300 further comprises planarization layer 332, rear dielectric layer 334, air or liquid medium 336, electrophoretically mobile particles 338, bias source 340, barrier layer 342, light diffuser layer 344 and OCA layer 346. Display 300 may further comprise sidewalls, directional front light, ALS, front light controller, front dielectric layer and a dielectric layer on the sidewalls (not shown in FIG. 3) as illustrated in display 100 in FIG. 1A.

Display 300 may be operated as follows. When particles 338 are moved towards front electrode 318 and into the evanescent wave region as shown to the left of dotted line 348, TIR may be frustrated and light may be absorbed by particles 338. This is represented by absorbed light ray 350. When electrophoretically mobile particles 338 are moved out of the evanescent wave region towards rear electrode 316, light may undergo total internal reflection at the interface of electrode 318 and medium 336. This is represented by incident light ray 352 being totally internally reflected as light ray 354 which is then reflected back towards viewer 306.

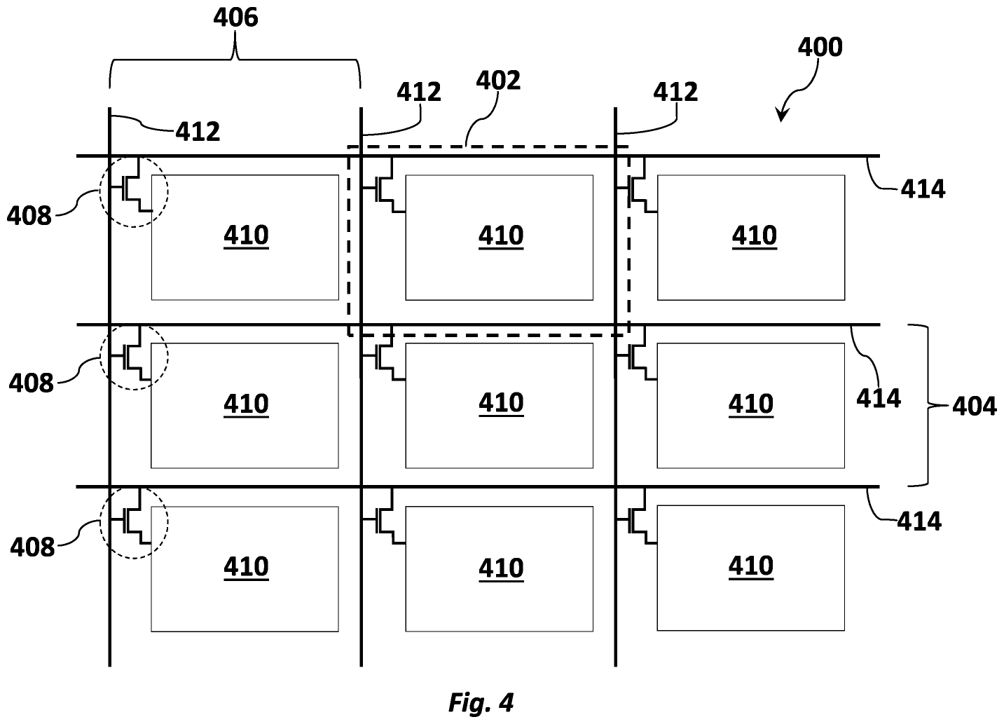

In exemplary embodiments, any of the display embodiments described herein may be driven by backplane electronics comprising an active matrix thin film transistor array typically used in liquid crystal displays (LCDs). FIG. 4 schematically illustrates an embodiment of a portion of an active matrix thin film transistor array for driving a rigid, flexible or conformal TIR-based display. Backplane electronics embodiment 400 is comprised of an array of sub-pixels 402 that may be used to drive a TIR-based display. A single sub-pixel 402 is highlighted by a dotted line box in FIG. 4. Sub-pixels 402 may be in any size or shape. Sub-pixels 402 may be arranged in rows 404 and columns 406 as illustrated in FIG. 4 but other arrangements may be possible. In an exemplary embodiment, each sub-pixel 402 may comprise a single TFT 408. In array embodiment 400, each TFT 408 is located in the upper left of each sub-pixel 402. In other embodiments, the TFT 408 may be placed in other locations within each sub-pixel 402. Each sub-pixel 402 may further comprise a conductive layer 410 to address each sub-pixel of the display. Layer 410 may comprise ITO, aluminum, copper, gold, Baytron™, or conductive nanoparticles, silver wires, metal nanowires, graphene, nanotubes, or other conductive carbon allotropes or a combination of these materials dispersed in a polymer. Backplane electronics embodiment 400 may further comprise column 412 and row 414 wires. Column wires 412 and row wires 414 may comprise a metal such as aluminum, copper, gold or other electrically conductive metal. Column 412 and row 414 wires may comprise ITO. The column 412 and row 414 wires may be attached to TFTs 408. Sub-pixels 402 may be addressed in rows and columns. TFTs 408 may be formed using amorphous silicon or polycrystalline silicon. The silicon layer for TFTs 408 may be deposited using plasma-enhanced chemical vapor deposition (PECVD). In an exemplary embodiment, each sub-pixel 402 may be substantially aligned with a single sub-pixel color filter in layer 208, 308 and further aligned with convex protrusions of a substantially distinct size and shape (such as convex protrusions 320 aligned with red filter 322 in FIG. 3 as previously described herein). In an exemplary embodiment, each sub-pixel 402 may be used to drive particles towards or away from the front electrode adjacent the location of a color filter sub-pixel. Column wires 412 and row wires 414 may be further connected to integrated circuits and drive electronics to drive the display.

In an exemplary embodiment, any of the reflective image display embodiments disclosed herein may be rigid, flexible or conformable. In some embodiments, the components of the reflective image display embodiments disclosed herein may be flexible and may provide rigidity and stability to said reflective image display embodiments disclosed herein.

In other embodiments, any of the reflective image display embodiments disclosed herein may further include at least one spacer structure (not shown). The spacer structures may be used to control the gap between the front and rear electrodes. Spacer structures may be used to support the various layers in the displays. The spacer structures may be in the shape of circular or oval beads, blocks, cylinders or other geometrical shapes or combinations thereof. The spacer structures may comprise glass, metal, plastic or other resin.

At least one edge seal (not shown) may be employed with the disclosed display embodiments. The edge seal may prevent ingress of moisture or other environmental contaminants from entering the display. The edge seal may be a thermally, chemically or a radiatively cured material or a combination thereof. The edge seal may comprise one or more of an epoxy, silicone, polyisobutylene, acrylate or other polymer based material. In some embodiments the edge seal may comprise a metallized foil. In some embodiments, the edge seal may comprise a filler such as SiO₂ or Al₂O₃.

In some embodiments, a porous reflective layer (not shown) may be used in combination with the disclosed display embodiments. The porous reflective layer may be interposed between the front and rear electrode layers. In other embodiments the rear electrode may be located on the surface of the porous electrode layer.

Various control mechanisms for the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

In some embodiments, a tangible machine-readable non-transitory storage medium that contains instructions may be used in combination with the disclosed display embodiments. In other embodiments the tangible machine-readable non-transitory storage medium may be further used in combination with one or more processors.

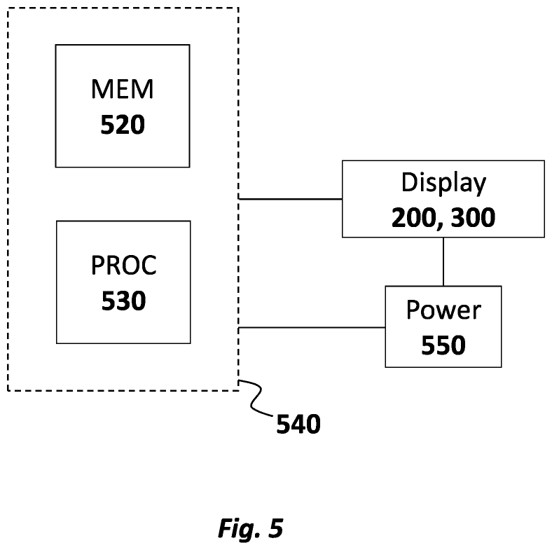

FIG. 5 shows an exemplary system for controlling a display according to one embodiment of the disclosure. In FIG. 5, display 200, 300 is controlled by controller 540 having processor 530 and memory 520. Other control mechanisms and/or devices may be included in controller 540 without departing from the disclosed principles. Controller 540 may define hardware, software or a combination of hardware and software. For example, controller 540 may define a processor programmed with instructions (e.g., firmware). Processor 530 may be an actual processor or a virtual processor. Similarly, memory 520 may be an actual memory (i.e., hardware) or virtual memory (i.e., software).

Memory 520 may store instructions to be executed by processor 530 for driving display 200, 300. The instructions may be configured to operate display 200, 300. In one embodiment, the instructions may include biasing electrodes associated with display 200, 300 through power supply 550. When biased, the electrodes may cause movement of electrophoretic particles towards or away from a region proximal to the surface of the plurality of protrusions at the inward surface of the front transparent sheet to thereby absorb or reflect light received at the inward surface of the front transparent sheet. By appropriately biasing the electrodes, particles (e.g., particles 238 in FIG. 2; particles 338 in FIG. 3) may be moved near the surface of the plurality of protrusions at the inward surface of the front transparent sheet into or near the evanescent wave region in order to substantially or selectively absorb or reflect the incoming light. Absorbing the incoming light may create a dark or colored state. By appropriately biasing the electrodes, particles (e.g., particles 238 in FIG. 2; particles 338 in FIG. 3) may be moved away from the surface of the plurality of protrusions at the inward surface of the front transparent sheet and out of the evanescent wave region in order to reflect or absorb the incoming light. Reflecting the incoming light creates a light state.

In the exemplary display embodiments described herein, they may be used in Internet of Things (IoT) devices. The IoT devices may comprise a local wireless or wired communication interface to establish a local wireless or wired communication link with one or more IoT hubs or client devices. The IoT devices may further comprise a secure communication channel with an IoT service over the interne using a local wireless or wired communication link. The IoT devices comprising one or more of the display devices described herein may further comprise a sensor. Sensors may include one or more of a temperature, humidity, light, sound, motion, vibration, proximity, gas or heat sensor. The IoT devices comprising one or more of the display devices described herein may be interfaced with home appliances such as a refrigerator, freezer, television (TV), close captioned TV (CCTV), stereo system, heating, ventilation, air conditioning (HVAC) system, robotic vacuum, air purifiers, lighting system, washing machine, drying machine, oven, fire alarms, home security system, pool equipment, dehumidifier or dishwashing machine. The IoT devices comprising one or more of the display devices described herein may be interfaced with health monitoring systems such as heart monitoring, diabetic monitoring, temperature monitoring, biochip transponders or pedometer. The IoT devices comprising one or more of the display devices described herein may be interfaced with transportation monitoring systems such as those in an automobile, motorcycle, bicycle, scooter, marine vehicle, bus or airplane. The IoT devices may comprise a touch screen. The IoT devices may further comprise a voice recognition system.

In the exemplary display embodiments described herein, they may be used in IoT and non-IoT applications such as in, but not limited to, electronic book readers, portable computers, tablet computers, cellular telephones, smart cards, signs, watches, smart watches, fitness tracker (e.g., Fitbit™), wearables, military display applications, automotive displays, automotive license plates, shelf labels, flash drives and outdoor billboards or outdoor signs comprising a display. The automotive displays may include a dashboard, an odometer, speedometer, gas gauge, audio system or rear back up camera. The displays may be powered by one or more of a battery, solar cell, wind power, electrical generator, electrical outlet, AC power, DC power or other means.

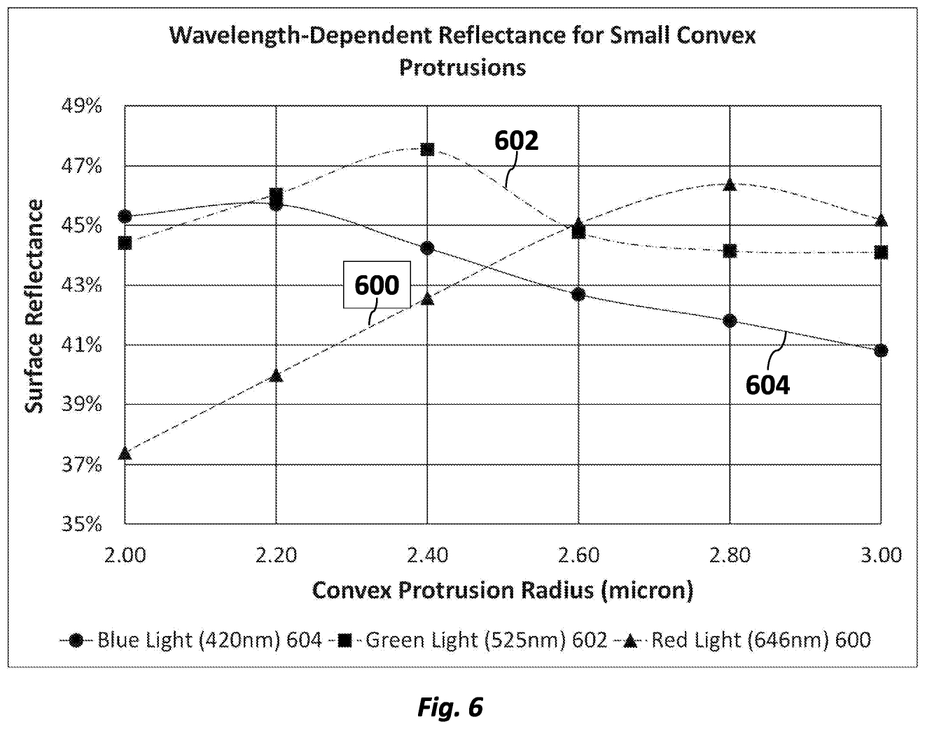

FIG. 6 graphically illustrates the reflectance of light in a display as a function of convex protrusion size at different wavelengths of light. Using finite-difference time-domain simulations, the sizes and shapes of the convex protrusions (i.e. optical structures) may be determined that preferentially and optimally reflects light at the wavelengths required to match the color filter display. Simulations were done using Lumerical, Inc. (Vancouver, Canada) FDTD Solutions software package (version 2016a). Hemispherical shaped convex protrusions similar to protrusions 108, 210, 310 in FIGS. 1-3 were examined with radius less than 4 microns. The x-axis in the graph in FIG. 6 is the radius of the convex protrusions examined. The y-axis is the resulting surface reflectance. The higher surface reflectance may lead to a brighter display. Several wavelengths of red, green and blue light were examined for the incident light. The graph in FIG. 6 illustrates representative wavelengths of 646 nm for red light 600, 525 nm for green light 602 and 420 nm for blue light 604. At about a 2.8 micron hemisphere radius, red light 600 showed a maximum reflectance of about 46%, at 2.4 micron hemisphere radius green light 602 exhibited a maximum reflectance of about 48% and at 2.20 micron hemisphere radius, blue light 604 showed a maximum reflectance of about 46%. Non-tuned hemispheres exhibit a reflectance of about 43% for all wavelengths used. These peaks illustrated in FIG. 6 exhibit about a 7% gain relative to a non-tuned hemisphere.

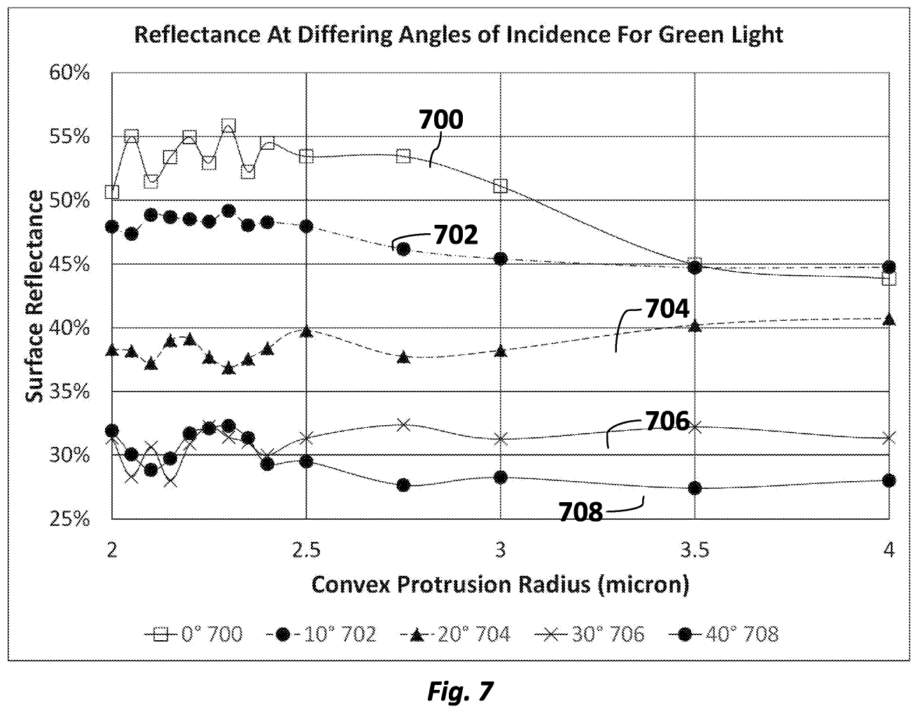

FIG. 7 graphically illustrates the reflectance of light in a display as a function of convex protrusion size at different angles of incidence of light. The data graphically illustrated in FIG. 7 is from directing, by means of computer simulation, representative green light at 550 nm at varying angles of incidence onto the surface of an array of hemispherical-like convex protrusions with different radii of 2 to 4 microns. The angles of incidence used were 0° 700, 10° 702, 20° 704, 30° 706 and 40° 708 from normal to the surface of the convex protrusion. The simulations show that the peaks do not move with respect to wavelength as the angle of the incident light changes. This implies that the structures may be tuned without worrying about losing reflectance in non-normal viewing conditions, although the gain in non-normal viewing conditions may decrease.

The following non-limiting examples are provided to further illustrate certain embodiments of the disclosure. These examples are exemplary and non-limiting of the disclosed principles. Example 1 is directed to a total internal reflection (TIR) display, comprising: a transparent front sheet; a color filter layer further comprising a sub-pixel adjacent the front sheet, the color filter sub-pixel substantially allowing rays of a primary wavelength band to pass through; a protrusion extending away from the transparent front sheet; a rear electrode positioned to form a cavity with the transparent front sheet; and wherein the protrusion extending from the transparent front sheet is configured to maximize internal reflectance within the primary wavelength band.

Example 2 is directed to the TIR display of example 1, wherein the protrusion extending from the transparent front sheet is shaped to maximize internal reflectance of the primary wavelength band.

Example 3 is directed to the TIR display of example 1, wherein the protrusion extending from the transparent front sheet is sized to maximize internal reflectance of the primary wavelength band.

Example 4 is directed to the TIR display of example 1, wherein the color filter layer comprises one or more color filter sub-pixels with transmission wavelength bands corresponding to the color red, green, blue, clear, white, cyan, magenta, and yellow.

Example 5 is directed to the TIR display of example 1, further comprising a front electrode adjacent the front sheet, the front electrode and the rear electrode biased to form an electric field therebetween.

Example 6 is directed to the TIR display of example 1, wherein the color filter is integrated with the transparent front sheet.

Example 7 is directed to the TIR display of example 1, wherein the color filter is positioned proximal to the transparent front sheet.

Example 8 is directed to the TIR display of example 1, further comprising sidewalls extending from the transparent front sheet to partition at least a portion of the display.

Example 9 is directed to the TIR display of example 1, wherein the at least one protrusion is formed adjacent the color filter layer.

Example 10 is directed to the TIR display of example 1, further comprising a medium disposed in the cavity and a plurality of electrophoretically mobile particles suspended in the medium.

Example 11 is directed to a display system to provide total internal reflection (TIR) of an incoming ray, comprising: a transparent front sheet; a plurality of color filter sub-pixels adjacent the front sheet, each of the plurality of the color filter sub-pixels substantially allowing a corresponding primary wavelength band to pass therethrough; a plurality of protrusions extending away from the transparent front sheet, each of the plurality of protrusions corresponding to one of the plurality of the color filter sub-pixels, wherein at least one of the plurality of protrusions is aligned with a corresponding color filter sub-pixel; a rear electrode positioned to form a cavity with the transparent front sheet; and wherein each of the plurality of protrusions is configured to maximize internal reflectance of the primary wavelength band associated with the corresponding color filter sub-pixel.

Example 12 is directed to the display system of example 11, wherein at least one of the protrusions extending from the transparent front sheet is shaped or sized to maximize internal reflectance of the primary wavelength band associated with the corresponding color filter.

Example 13 is directed to the TIR system display of example 11, wherein the color filter layer comprises one or more optical filters, each filter having a corresponding transmission wavelength bands corresponding to the color, red, green, blue, clear, cyan, magenta, and yellow.

Example 14 is directed to the TIR system display of example 11, further comprising a front electrode adjacent the front sheet, the front electrode and the rear electrode biased to form an electric field therebetween.

Example 15 is directed to the TIR system display of example 11, wherein the color filter layer is one of integrated with the transparent front sheet or positioned proximal to the transparent front sheet.

Example 16 is directed to the TIR system display of example 11, further comprising sidewalls extending from the transparent front sheet to partition at least a portion of the display.

Example 17 is directed to the TIR system display of example 11, wherein the at least one protrusion is formed adjacent the color filter layer.

Example 18 is directed to the TIR system display of example 11, further comprising a medium disposed in the cavity and a plurality of electrophoretically mobile particles suspended in the medium.

Example 19 is directed to a method to provide a total internal reflection (TIR) from a display, the method comprising: receiving an incoming ray at a color filter sub-pixel, the color filter sub-pixel in the color filter layer substantially allowing rays of a primary wavelength band to pass therethrough; directing the incoming ray to enter a protrusion, the protrusion configured to maximize internal reflectance of the primary wavelength band; and biasing a rear electrode relative to a front electrode to a first state to thereby move a plurality of electrophoretically mobile particles in a cavity formed between the rear electrode and the front electrode, wherein the protrusion causes a portion of the rays to reflect from the protrusion as a result of one or more reflections via total internal reflection.

Example 20 is directed to the method of example 19, wherein the protrusion is configured to one of internally reflect the incoming ray back to the color filter sub-pixel or pass the incoming ray therethrough.

Example 21 is directed to the method of example 19, wherein the electrophoretically mobile particles are suspended in a medium.

Example 22 is directed to the method of example 19, further comprising biasing the rear electrode relative to the front electrode to the first state to thereby move a plurality of electrophoretically mobile particles in a cavity adjacent the front electrode to thereby absorb the incoming ray.

Example 23 is directed to the method of example 19, further comprising biasing the rear electrode relative to the front electrode to a second state to thereby move the plurality of electrophoretically mobile particles in the cavity towards the rear electrode to thereby totally internally reflect the incoming ray.

Example 24 is directed to the method of example 19, wherein the protrusion is shaped to maximize internal reflectance of the primary wavelength band.

Example 25 is directed to the method of example 19, wherein the color filter layer comprises one or more color filter sub-pixels with transmission wavelength bands corresponding to the color red, green, blue, clear, cyan, magenta, and yellow.

Example 26 is directed to the method of example 19, further controlling the biasing of the rear electrode relative to the front electrode to provide TIR.

Example 27 is directed to the method of example 19, further comprising sensing an ambient condition and biasing the rear electrode relative to the front electrode as a function of the ambient condition.

While the principles of the disclosure have been illustrated in relation to the exemplary embodiments shown herein, the principles of the disclosure are not limited thereto and include any modification, variation or permutation thereof.

What is claimed is:

1. A total internal reflection (TIR) display, comprising:
a transparent front sheet;
a color filter layer further comprising a sub-pixel adjacent the front sheet, the color filter sub-pixel substantially allowing rays of a primary wavelength band to pass through;
a protrusion extending away from the transparent front sheet;
a rear electrode positioned to form a cavity with the transparent front sheet; and
wherein the protrusion extending from the transparent front sheet is configured to maximize internal reflectance within the primary wavelength band.

2. The TIR display of claim 1, wherein the protrusion extending from the transparent front sheet is shaped to maximize internal reflectance of the primary wavelength band.

3. The TIR display of claim 1, wherein the protrusion extending from the transparent front sheet is sized to maximize internal reflectance of the primary wavelength band.

4. The TIR display of claim 1, wherein the color filter layer comprises one or more color filter sub-pixels with transmission wavelength bands corresponding to the color red, green, blue, clear, white, cyan, magenta, and yellow.

5. The TIR display of claim 1, further comprising a front electrode adjacent the front sheet, the front electrode and the rear electrode biased to form an electric field therebetween.

6. The TIR display of claim 1, wherein the color filter is integrated with the transparent front sheet.

7. The TIR display of claim 1, wherein the color filter is positioned proximal to the transparent front sheet.

8. The TIR display of claim 1, further comprising sidewalls extending from the transparent front sheet to partition at least a portion of the display.

9. The TIR display of claim 1, wherein the at least one protrusion is formed adjacent the color filter layer.

10. The TIR display of claim 1, further comprising a medium disposed in the cavity and a plurality of electrophoretically mobile particles suspended in the medium.

11. A display system to provide total internal reflection (TIR) of an incoming ray, comprising:
a transparent front sheet;
a plurality of color filter sub-pixels adjacent the front sheet, each of the plurality of the color filter sub-pixels substantially allowing a corresponding primary wavelength band to pass therethrough;
a plurality of protrusions extending away from the transparent front sheet, each of the plurality of protrusions corresponding to one of the plurality of the color filter sub-pixels, wherein at least one of the plurality of protrusions is aligned with a corresponding color filter sub-pixel;
a rear electrode positioned to form a cavity with the transparent front sheet; and
wherein each of the plurality of protrusions is configured to maximize internal reflectance of the primary wavelength band associated with the corresponding color filter sub-pixel.

12. The display system of claim 11, wherein at least one of the protrusions extending from the transparent front sheet is shaped or sized to maximize internal reflectance of the primary wavelength band associated with the corresponding color filter.

13. The TIR system display of claim 11, wherein the color filter layer comprises one or more optical filters, each filter having a corresponding transmission wavelength bands corresponding to the color, red, green, blue, clear, cyan, magenta, and yellow.

14. The TIR system display of claim 11, further comprising a front electrode adjacent the front sheet, the front electrode and the rear electrode biased to form an electric field therebetween.

15. The TIR system display of claim 11, wherein the color filter layer is one of integrated with the transparent front sheet or positioned proximal to the transparent front sheet.

16. The TIR system display of claim 11, further comprising sidewalls extending from the transparent front sheet to partition at least a portion of the display.

17. The TIR system display of claim 11, wherein the at least one protrusion is formed adjacent the color filter layer.

18. The TIR system display of claim 11, further comprising a medium disposed in the cavity and a plurality of electrophoretically mobile particles suspended in the medium.

19. A method to provide a total internal reflection (TIR) from a display, the method comprising:
receiving an incoming ray at a color filter sub-pixel, the color filter sub-pixel in the color filter layer substantially allowing rays of a primary wavelength band to pass therethrough;
directing the incoming ray to enter a protrusion, the protrusion configured to maximize internal reflectance of the primary wavelength band; and
biasing a rear electrode relative to a front electrode to a first state to thereby move a plurality of electrophoretically mobile particles in a cavity formed between the rear electrode and the front electrode
wherein the protrusion causes a portion of the rays to reflect from the protrusion as a result of one or more reflections via total internal reflection.

20. The method of claim 19, wherein the protrusion is configured to one of internally reflect the incoming ray back to the color filter sub-pixel or pass the incoming ray therethrough.

21. The method of claim 19, wherein the electrophoretically mobile particles are suspended in a medium.

22. The method of claim 19, further comprising biasing the rear electrode relative to the front electrode to the first state to thereby move a plurality of electrophoretically mobile particles in a cavity adjacent the front electrode to thereby absorb the incoming ray.

23. The method of claim 19, further comprising biasing the rear electrode relative to the front electrode to a second state to thereby move the plurality of electrophoretically mobile particles in the cavity towards the rear electrode to thereby totally internally reflect the incoming ray.

24. The method of claim 19, wherein the protrusion is shaped to maximize internal reflectance of the primary wavelength band.

25. The method of claim 19, wherein the color filter layer comprises one or more color filter sub-pixels with transmission wavelength bands corresponding to the color red, green, blue, clear, cyan, magenta, and yellow.

26. The method of claim 19, further controlling the biasing of the rear electrode relative to the front electrode to provide TIR.

27. The method of claim 19, further comprising sensing an ambient condition and biasing the rear electrode relative to the front electrode as a function of the ambient condition.
